(19) United States
(12) Patent Application Publication
(10) Pub. No.: US 2016/0156699 A1
(43) Pub. Date: Jun. 2, 2016

(54) Intelligent Content Management System for Effective Knowledge Transfer

(71) Applicant: SmartStory Technologies, Inc., Boise, ID (US)

(72) Inventor: Michael Boerner, Boise, ID (US)

(21) Appl. No.: 15/019,039

(22) Filed: Feb. 9, 2016

Related U.S. Application Data
(63) Continuation of application No. 12/466,259, filed on May 14, 2009, now abandoned.
(60) Provisional application No. 61/053,212, filed on May 14, 2008.

(51) Int. Cl. H04L 29/08; H04L 29/06

(52) U.S. Cl. CPC H04L 67/06; H04L 67/42; H04L 67/02

(57) ABSTRACT

A computer implemented content management system providing for facilitating the exchange of information between a Professional and a Client.

### PRIORITY/CROSS-REFERENCE TO RELATED APPLICATIONS

This application is a non-provisional of Application No. 61/053,212, filed May 14, 2008, titled “System and Method for Communicating with Clients through use of a Content Management System,” the disclosure of which is incorporated herein by reference.

### BRIEF DESCRIPTION OF THE DRAWINGS

FIG. 1 is a flow chart of a method according to a preferred embodiment of the invention.

FIG. 2 is a block diagram of an exemplary computer system.

FIG. 3 is a block diagram of a system according to a preferred embodiment of the invention.

### DESCRIPTION OF THE PREFERRED EMBODIMENTS

While the invention is susceptible of various modifications and alternative constructions, certain illustrated embodiments thereof have been shown in the figures and will be described below in detail. It should be understood, however, that there is no intention to limit the invention to the specific form disclosed, but, on the contrary, the invention is to cover all modifications, alternative constructions, and equivalents falling within the spirit and scope of the invention as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

Embodiments of the present invention are particularly useful facilitating the communication between a “Professional” and at least one “Client.”

The terms “Client” and “Customer” are intended in their broadest senses, used generically to refer to a person (or persons) to whom information must be conveyed, and, in some instances, feedback obtained, including but not limited to clients, customers, readers, viewers, fans, patients, employees, friends, colleagues, students, etc. Where confusion in this disclosure might result between the terms “Client” and “client computer,” the term “Customer” is used. Applicant intends Client and Customer to be interchangeable as used herein.

The term “Professional” intended broadly as well, including but not limited to businesses, doctors, counselors, parents, attorneys, employers, pastors, supervisors, teachers, instructors, authors, musicians, etc.

The term “client-server network” refers to a network where one or more servers are coupled to one or more clients over a communications channel.

The terms “computer system,” “computer,” “client computer,” and “server computer,” as used herein, include but are not limited to a personal computer system, a work station computer system, a lap top computer system, a “netbook” computer system, an embedded controller system, a microprocessor-based system, a digital signal processor-based system, a hand held device system, a personal digital assistant (PDA) system, a cell phone, a wireless system, a wireless networking system, and an Internet capable device.

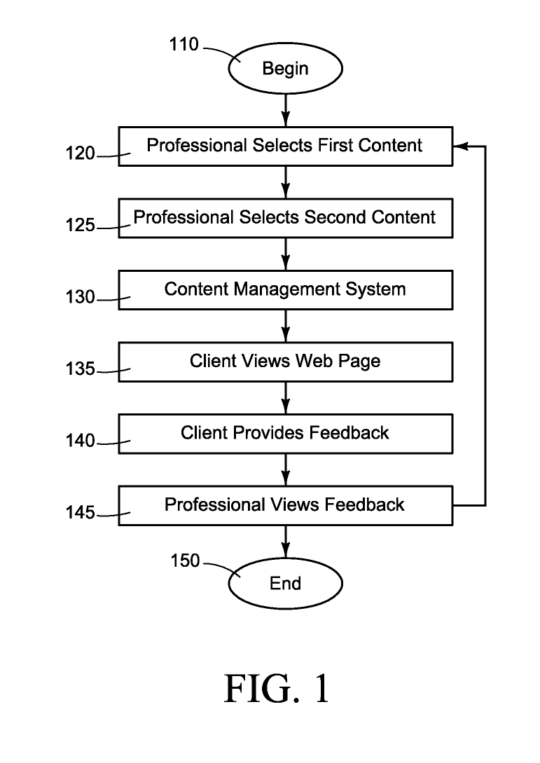

The flow chart of FIG. 1 illustrates the knowledge transfer platform architecture showing the interaction of the various subsystems according one preferred embodiment of the invention. In such an architecture, at least one client computer and at least one server computer are coupled together in the typical manner.

The process begins at step 110. At step 120 a Professional, preferably using a client computer having a software user interface, selects a plurality of content items to be communicated to a Client. For instance, the selected content items could comprise a plurality of embedded videos, multi-media content, or other audio-visual content that the Client is able to view on a computer screen or other display. The selection of these videos custom tailored by the Professional to the needs of the Client and/or the Professional-Client relationship. This selected content can be generated and/or supplied by the Professional, or can be provided by a third party, and includes any suitable content, including but not limited to audio clips, video clips, diagnostic tools, personality tests, marriage evaluation tests, and documents, as well as links to the same. The content preferably stored on a storage device coupled to the client-server computer network.

The third party content may be pregrouped, tagged or otherwise presented within the CMS interface to the Professional in an orderly manner, thereby enabling the Professional to quickly select desired content, for instance a series of videos on a particular topic. It is envisioned that a database of content would be provided and stored, the Professional able to select which content (such as video clips) would be displayed to a particular Client. By creating a database of content performed by national experts on relevant topics, the Professional would have ready access to a tremendous resource to both the Professional and the Professional's Clients.

At step 125, the Professional may supplement the selected content items with additional content provided by the Professional his/herself (e.g., text, greetings, introductions, summaries, video content, audio content). This additional content could comprise at least one question from the Professional to the Client. For instance, the Professional could select to associate a question to be answered by the Client with one (or more) of the audio-visual content items, thereby asking the Client for feedback (hereinafter “Feedback”) based upon the Client's review of the content. This Feedback could be provided from the Client to the Professional via textual input into a form, uploaded files, recorded audio and/or video, or otherwise. The “audio-video content items” and “additional content items” collectively referred to herein as “the Content.”

At step 130, the Content and/or Content selection is received either by a server computer or in some other way by a provider of such Content for display to said Client. The Professional thereby generating a request to the server computer to create a new web page containing said content. The server computer publishing said video content selections on said new web page for viewing by said Client.

At step 135, the Client may use a second client computer system, preferably having a software user interface connected there-to, to interact with the server computer via a communications network such as the Internet or a Local Area Network (LAN) to access the Content. This may involve filling in a form on a web page and sending the form to the server via a hypertext protocol operation such as a ‘post’ or ‘get’ operation, or it may involve sending an electronic mail message, or may involve communicating by any other suitable protocol.

At step 140, after viewing the Content, the Client may provide Feedback to the Professional, for instance by answering said questions, the server computer configured for receiving such Feedback. This Feedback may be stored within a knowledge feedback engine or other storage device coupled to the client-server computer network. The Feedback can be published by the server computer on the web page. The Client may provide such Feedback through a software user interface connected to a second client computer. The Feedback published by the server computer on the web page may be password protected, or otherwise hidden from view by the Client, the Professional or another party.

At step 145, the Professional reviews the Client's Feedback and proceeds with the Professional's relationship with the Client (e.g., selecting additional Content to be displayed for Client (repeating the process), communicating with the Client to discuss the Content and/or Feedback, meeting with the Client to discuss the Content and/or Feedback, suggesting a treatment or therapy for the Client, providing advice to the Client). At step 150, the process ends.

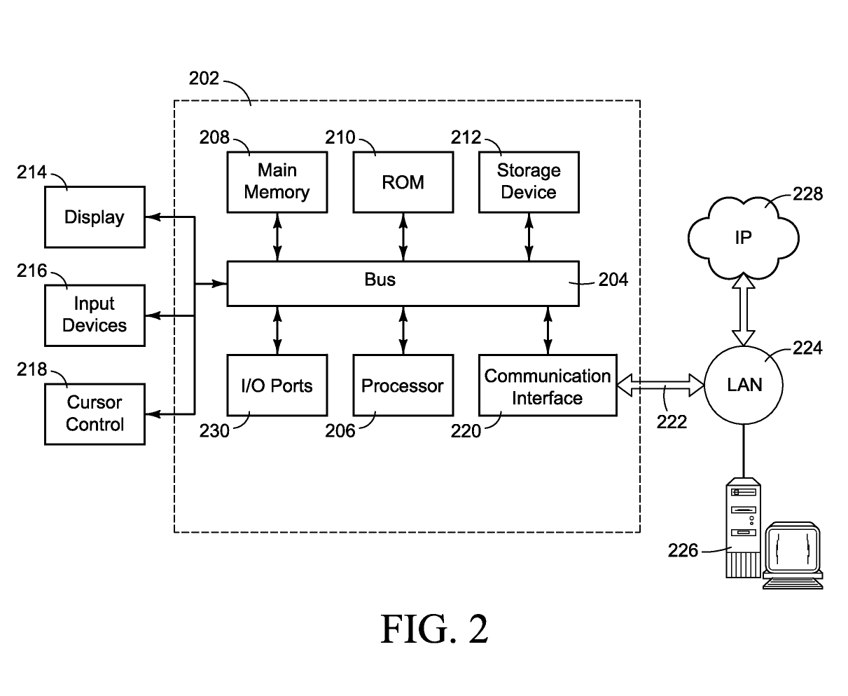

FIG. 2 illustrates a “computer system” 202 upon which the present invention may be implemented. The computer system 202 includes a bus 204 or other communication mechanism for communicating information and a processor 206 coupled with bus 204 for processing the information. The computer system 202 also includes a main memory 208, such as a random access memory (RAM) or other dynamic storage device (e.g., dynamic RAM (DRAM), static RAM (SRAM), synchronous DRAM (SDRAM), flash RAM), coupled to bus 204 for storing information and instructions to be executed by processor 206. In addition, main memory 208 may be used for storing temporary variables or other intermediate information during execution of instructions to be executed by processor 206. Computer system 202 further includes a read only memory (ROM) 210 or other static storage device (e.g., programmable ROM (PROM), erasable PROM (EPROM), and electrically erasable PROM (EEPROM)) coupled to bus 204 for storing static information and instructions for processor 206. A storage device 212, such as a magnetic disk or optical disk, is provided and coupled to bus 204 for storing information and instructions.

The computer system 202 also includes input/output ports 230 to couple the computer system 202 to external devices. Such coupling may include direct electrical connections, wireless connections, networked connections, etc., for implementing automatic control functions, remote control functions, etc.

The computer system 202 may also include special purpose logic devices (e.g., application specific integrated circuits (ASICs)) or configurable logic devices (e.g., generic array of logic (GAL) or re-programmable field programmable gate arrays (FPGAs)). Other removable media devices (e.g., a compact disc, a tape, and a removable magneto-optical media) or fixed, high-density media drives, may be added to the computer system 202 using an appropriate device bus (e.g., a small computer system interface (SCSI) bus, an enhanced integrated device electronics (IDE) bus, or an ultra-direct memory access (DMA) bus). The computer system 202 may additionally include a compact disc reader, a compact disc reader-writer unit, or a compact disc jukebox, each of which may be connected to the same device bus or another device bus.

The computer system 202 may be coupled via bus 204 to a display 214, such as a cathode ray tube (CRT), liquid crystal display (LCD), voice synthesis hardware and/or software, etc., for displaying and/or providing information to a computer user. The display 214 may be controlled by a display or graphics card. The computer system includes input devices, such as a keyboard 216 and a cursor control 218, for communicating information and command selections to processor 206. Such command selections can be implemented via voice recognition hardware and/or software functioning as the input devices 216. The keyboard 216 may be a touch screen display. The cursor control 218, for example, is a mouse, a trackball, cursor direction keys, touch screen display, optical character recognition hardware and/or software, etc., for communicating direction information and command selections to processor 206 and for controlling cursor movement on the display 214. In addition, a printer may provide printed listings of the data structures, information, etc., or any other data stored and/or generated by the computer system 202.

The computer system 202 performs a portion or all of the processing steps of the invention in response to processor 206 executing one or more sequences of one or more instructions contained in a memory, such as the main memory 208. Such instructions may be read into the main memory 208 from another computer readable medium, such as storage device 212. One or more processors in a multi-processing arrangement may also be employed to execute the sequences of instructions contained in main memory 208. In alternative embodiments, hard-wired circuitry may be used in place of or in combination with software instructions. Thus, embodiments are not limited to any specific combination of hardware circuitry and software.

As stated above, the system 202 includes at least one computer readable medium or memory programmed according to the teachings of the invention and for containing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling the computer system 202, for driving a device or devices for implementing the invention, and for enabling the computer system 202 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 206 for execution. A computer readable medium may take many forms, including but not limited to, non-volatile media, volatile media, and transmission media. Non-volatile media includes, for example, optical, magnetic disks, and magneto-optical disks, such as storage device 212. Volatile media includes dynamic memory, such as main memory 208. Transmission media includes coaxial cables, copper wire and fiber optics, including the wires that comprise bus 204. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 206 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 202 may receive the data on the telephone line and use an infrared transmitter to convert the data to an infrared signal. An infrared detector coupled to bus 204 can receive the data carried in the infrared signal and place the data on bus 204. The bus 204 carries the data to main memory 208, from which processor 206 retrieves and executes the instructions. The instructions received by main memory 208 may optionally be stored on storage device 212 either before or after execution by processor 206.

The computer system 202 also includes a communication interface 220 coupled to bus 204. Communication interface 220 provides a two-way data communication coupling to a network link 222 that may be connected to, for example, a local network 224. For example, communication interface 220 may be a network interface card to attach to any packet switched local area network (LAN). As another example, communication interface 220 may be an asymmetrical digital subscriber line (ADSL) card, an integrated services digital network (ISDN) card or a modem to provide a data communication connection to a corresponding type of telephone line. Wireless links may also be implemented via the communication interface 220. In any such implementation, communication interface 220 sends and receives electrical, electromagnetic or optical signals that carry digital data streams representing various types of information.

Network link 222 typically provides data communication through one or more networks to other data devices. For example, network link 222 may provide a connection to a computer 226 through local network 224 (e.g., a LAN) or through equipment operated by a service provider, which provides communication services through a communications network 228. In preferred embodiments, local network 224 and communications network 228 preferably use electrical, electromagnetic, or optical signals that carry digital data streams. The signals through the various networks and the signals on network link 222 and through communication interface 220, which carry the digital data to and from computer system 202, are exemplary forms of carrier waves transporting the information. The computer system 202 can transmit notifications and receive data, including program code, through the network(s), network link 222 and communication interface 220.

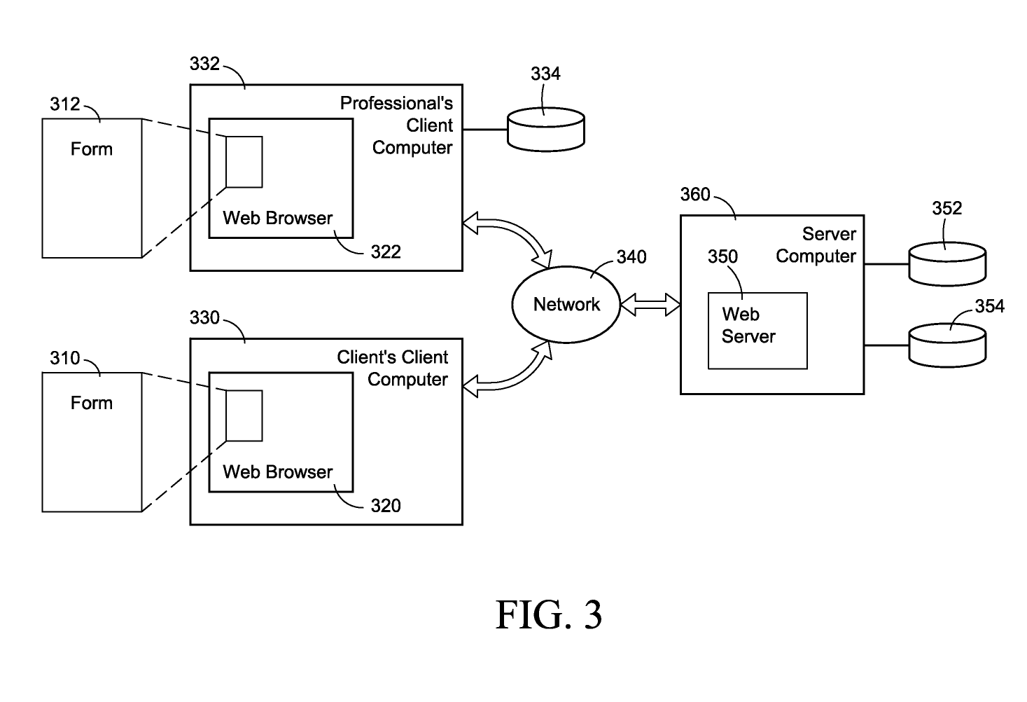

FIG. 3 shows a block diagram of a system according to a preferred embodiment of the invention. The Figure showing a computer implemented content management system (CMS) (a knowledge transform platform) for use by a Professional in fostering his/her relationship with a Client, the system (in this embodiment) including a Professional's client computer 332, a Client's client computer 330, and a server computer 360, all connected together via a network 340 (e.g., the Internet, a local area network (LAN)). Each of the client computers 330, 332 and the server computer 360 may incorporate the elements of the computer systems as described in relation to FIG. 2.

Knowledge content advisors (e.g., an expert in a field, a trusted website) provide a source of content (e.g., audio files, video files, written materials). A content repository 352, connected to the client-server network, stores content from the knowledge content advisors. A separate content repository 334 represents any content generated by the Professional that is uploaded into the system.

The Server Computer 360 serves content from the content repository 352 to a Client's client computer (or other knowledge access client, e.g., software, web page, client computer, cell phone, Internet connected device).

A Professional can, for instance through a connected client computer, such as the Professional's client computer 332, search the content repository 352 via the server computer 360, and select content from the content repository 352 to be transmitted to a Client.

The Professional can upload content, including but not limited to text, video, audio and documents to the content repository 352 via the web server 360 for selection and transmission as well. This content may be stored in the Professional's own content repository 334.

A knowledge feedback engine 354 may also be present, the knowledge feedback engine connecting to the client-server network. The knowledge feedback engine sorts comments, questions and information from the Client, some of which are provided via the Client's client computer, and connects with the server computer.

As described in FIG. 1, the Professional's content selection and other input (the “Content”) might be entered into or selected via a form 312 on a web browser 322 on the Professional's client computer 332. This information communicated via the network 340 to a web server program 350 running on the server computer 360. Copies of any audio-video content generated and/or supplied by the Professional may be uploaded to the server computer and stored, for instance within content repository 352. Alternatively, the audio-video content generated and/or supplied by the Professional could be streamed or otherwise made available to the Client.

The Client could then enter a request for the Content into a request form 310 in a web browser 320 on the Client's client computer 330, the request is communicated via the network 340 to the web server program 350 running on the server computer 360. The web server program 350 communicating the Content, including any selected audio-video content stored in the direct access storage 352, to the Client's client computer 330.

The Client may provide feedback or comments to the Professional, for instance by answering any questions the Professional posed to the Client, via a request form 310 in a web browser 320 on the Client's client computer 330, the feedback (request) communicated via the network 340 to the web server program 350 running on the server computer 360 and stored in the knowledge feedback engine 354, communicated to the Professional, or otherwise processed and handled.

The protocols that may be used have been discussed previously. The method as shown in FIG. 1 may then take place either as a series of steps in a stored program run on the server computer or on another computer, and any or all portions of this method may instead be performed manually by the content provider.

The disclosed invention may take a number of forms, including to but not limited to the following examples and combinations of elements of said examples.

Marriage Counselor Example. A first example use of the present invention would be within the framework of a marriage counselor's practice. The Professional is a marriage counselor, and there is a pair of Clients (the married couple undergoing counseling). The counselor could create a first custom web page for display to the wife, and a second custom web page for display to the husband. During a counseling session (for instance, the first counseling session), the counselor might indicate to the counselees that as part of his counseling plan he wanted to utilize a web based video system. In utilizing this system, both the husband and the wife would each be given a unique URL to access a password-protected web page specifically created for each of them by the counselor.

Each counselee's web page might include a personalized textual greeting and introduction at the top, next to a video from the counselor, as well as any necessary information, for instance an indication of what the lesson “week” (if the counselor was using the tool over a number of weeks). Utilization of such a weekly model would result in the possibility of the counselor giving the counselees weekly “homework” in between face-to-face counseling sessions.

The counselee's web page might include a number of embedded video boxes, positioned along with related questions from the counselor. A text entry space could be provided under each video for the counselee to leave comments or other feedback after the counselee has watched the video for the counselor to review. It is also envisioned that the counselee could respond, not only in text, but also in video and/or audio if so desired. It is preferred that the counselee would be able to denote his/her responses as “draft” or “hold” whereby they would be saved by the system but not provided to the counselor. That would allow the counselee to compile their thoughts, and decide whether or not to share them with the counselor at a later time. Also provided would be the appropriate mechanism for the counselee to indicate which part (none, some, or all) of his or her input and comments may be shared with the other counselee or other individual participating in the counseling session.

The counselor could also provide additional question boxes (without videos to watch), along with input areas for the counselee to respond. The counselor could also embed a link (URL) to downloadable content, for instance, a personality test the counselor desires the counselee to take before the next counseling session. Links could also be added for whatever related articles, resources, discussion groups, etc. the counselor wished to share with the counselee.

Upon the counselee reviewing the content, the counselor could receive an e-mail or other status update from the CMS or otherwise informing the counselor that the counselee had viewed the web page, which of the content had be reviewed, and what feedback (if any) was left by the counselee. If follow up communication before the next counseling session was necessary, for instance in the case of an emergency, the counselor could do so.

If both counselees “do their prescribed homework,” the counselor would be able to compare answers left by both parties to further determine what the counselor's next course of action would be in the subsequent counseling session(s). If the counselees indicated that their answers could be shared with their spouse, the counselor would consider whether or not such disclosure was prudent and appropriate.

The method/system could likewise be configured for use with a widget or separate desktop program that would allow the counselor to, based upon responses, customize content delivered to the widget/program for later display and/or playing to the counselee. Additionally, utilizing such a widget/program, once the video is watched then a text box may open to enable input of textual comments.

Other types of counseling could particularly benefit from implementations of the disclosed invention, including but not limited to premarital counseling, financial counseling, divorce counseling, adultery recovery counseling, addiction counseling, and abuse counseling.

Small Group Example. In such an embodiment, the small group leader would select what Content (possibly including web videos, such as YouTube® videos, and other traditional media sources) would be displayable to the members of the small group, the group members could view the Content. The group members may be able to leave comments to the Content that are visible to the group leader and/or the other members of the small group. Comments left by external parties, such as members of other small groups, may be accessible by the group members as well.

Author-Reader Example. An author or publisher of a book could use an embodiment of the present invention to enable further discussion about the subject matter of the book. For instance, an author/publisher could create their own private “walled garden” where authors would include a URL at the end of a chapter of a book so that a reader of the book, upon reaching the end of the chapter, could go to a website that would display current discussion of the topics of the book. Such a feature would also enable the author to incorporate new materials and new teachings from current events into the discussion of the topics of her book without requiring the republishing of the book to include updates made well after the printed book has left the publisher.

Real Property Example. A cabin owner wishing to rent out or share his cabin with friends and/or renters could create a password protected web page only accessible to his guests, this website providing tutorials (video, audio, etc.) to his guests on such topics as driving directions to the property, the location of the spare key, how to operate the hot-tub, safety concerns, how to clean up after they are done using the cabin, etc.

Hospital Visit Example. A doctor or hospital could use an embodiment of the disclosed invention to provide information to patients and/or the families of patients. For instance, the web site could include videos regarding about where to park, explaining the procedure to be performed, satisfying requirements of the Health Insurance Portability and Accountability Act, providing informed consent, incorporating stock video and/or custom video, etc.

The purpose of the Abstract of the Disclosure is to enable the public, and especially the scientists, engineers, and practitioners in the art who are not familiar with patent or legal terms or phraseology, to determine quickly from a cursory inspection, the nature and essence of the technical disclosure of the application. The Abstract of the Disclosure is neither intended to define the invention of the application, which is measured by the claims, nor is it intended to be limiting as to the scope of the invention in any way.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A client-server computer network implemented method for managing communication between a Professional and a Customer, said method comprising the steps of:
storing a plurality of video content items on a storage device coupled to said client-server computer network;
through a software user interface connected to a first client computer, allowing said Professional to make a plurality of selections of said video content, and allowing said Professional to generate a request to a server computer to create a web page containing said video content selections, said first client computer coupled to said server computer; and
said server computer publishing said video content selections on a new web page for viewing by said Customer through use of a software user interface connected to a second client computer, said second client computer coupled to said server computer.

2. The client-server computer network implemented method of claim 1, wherein through said software user interface connected to said first client computer, allowing said Professional to submit additional content to be displayed with said video content selections, wherein said additional content includes at least one question for a Customer to answer, and wherein said additional content is included in the Professional's request to the server computer to create a web page.

3. The client-server computer network implemented method of claim 2, wherein additional content is published on said new web page.

4. The client-server computer network implemented method of claim 1, wherein said server computer is configured for receiving feedback from said Customer regarding the Customer's answers to said Professional's questions; and said server computer is configured to publish said feedback from said Customer on said new web page.

5. The client-server computer network implemented method of claim 1, wherein said feedback from said Customer is submitted through a software user interface connected to said second client computer.

6. The client-server computer network implemented method of claim 1, wherein said web page is password protected.

7. The client-server computer network implemented method of claim 1, wherein said Customer can designate that its feedback be kept private and not visible by said Professional.

8. The client-server computer network implemented method of claim 1, wherein said additional content comprises video content supplied by the Professional.

9. The client-server computer network implemented method of claim 1, wherein said additional content comprises multi-media content supplied by the Professional.

10. The client-server computer network implemented method of claim 1, wherein said additional content comprises at least one document.

11. The client-server computer network implemented method of claim 3, wherein through said software user interface connected to said first client computer, allowing said Professional to make a second plurality of selections of said video content, allowing said Professional to submit second additional content to be displayed with said second video content selections, wherein said second additional content includes at least one question for a Customer to answer, and allowing said Professional to generate a request to a server computer to create a second web page containing said video content selections and said additional content; wherein said server computer publishing said second video content selections and second additional content on a second new web page for viewing by said Customer through use of said software user interface connected to a second client computer.

12. The client-server computer network implemented method of claim 1, wherein said video content items are presented in a pregrouped fashion within said software user interface connected to said first client computer to said Professional, thereby enabling the Professional to select related content.

13. The client-server computer network implemented method of claim 1, wherein said feedback comprises textual input into a form by said Customer on said second client computer.

14. A client-server computer network implemented method for managing communication between a Professional and a Customer, said method comprising the steps of:
storing a plurality of video content items on a storage device coupled to said client-server computer network;
through a software user interface connected to a first client computer, allowing said Professional to make a plurality of selections of said video content, allowing said Professional to submit additional content to be displayed with said video content selections, wherein said additional content includes at least one question for a Customer to answer, and allowing said Professional to generate a request to a server computer to create a web page containing said video content selections and said additional content, said first client computer coupled to said server computer;
said server computer publishing said video content selections and additional content on a new web page for viewing by said Customer through use of a software user interface connected to a second client computer, said second client computer coupled to said server computer;
said server computer configured for receiving feedback from said Customer regarding the Customer's answers to said Professional's questions; and
said server computer publishing said feedback from said Customer on said new web page.

15. The client-server computer network implemented method of claim 14, wherein said web page is password protected, and wherein said Customer can designate that its feedback be kept private and not visible by said Professional.

16. The client-server computer network implemented method of claim 14, wherein through said software user interface connected to said first client computer, allowing said Professional to make a second plurality of selections of said video content, allowing said Professional to submit second additional content to be displayed with said second video content selections, wherein said second additional content includes at least one question for a Customer to answer, and allowing said Professional to generate a request to a server computer to create a second web page containing said video content selections and said additional content; wherein said server computer publishing said second video content selections and second additional content on a second new web page for viewing by said Customer through use of said software user interface connected to a second client computer.

17. The client-server computer network implemented method of claim 14, wherein said video content items are presented in a pregrouped fashion within said software user interface connected to said first client computer to said Professional, thereby enabling the Professional to select related content.

18. A computer implemented method for managing communication between a Professional and a Customer, said method comprising the steps of:
providing a server computer;
storing a plurality of video content items on a storage device coupled to said server computer;
receiving from said Professional a plurality of selections of video content;
receiving from said Professional at least one question to be displayed with said video content selections;
creating a web page containing said video content selections and said additional content;
publishing said video content selections and additional content on a new web page for viewing by said Customer;
receiving feedback from said Customer regarding the Customer's answer(s) to said Professional's at least one question; and
publishing said feedback on said new web page.
